(19) United States
(12) Patent Application Publication
(10) Pub. No.: US 2026/0028524 A1
(43) Pub. Date: Jan. 29, 2026

(54) BLEND OF PHOSPHONATE ACIDS FOR SCALE PREVENTION IN HIGH ALKALINITY AND HIGH CO2 ENVIRONMENTS

(71) Applicant: HALLIBURTON ENERGY SERVICES, INC, Houston, TX (US)

(72) Inventors: Zhiwei YUE, Houston, TX (US); Yi Tsung LU, Houston, TX (US); Gleydston Neri Dos SANTOS, Rio de Janeiro (BR)

(73) Assignee: HALLIBURTON ENERGY SERVICES, INC, Houston, TX (US)

(21) Appl. No.: 18/784,848

(22) Filed: Jul. 25, 2024

(51) Int. Cl. C09K 8/528

(52) U.S. Cl. CPC C09K 8/528

(57) ABSTRACT

Treatment fluids and methods for preventing the formation of scale. A treatment fluid is provided to the wellbore. The treatment fluid is composed of polyamino polyether methylene phosphonate (PAPEMP), aminoethylethanolamine tri(methylene phosphonate) (AEEA), an organic acid, and an aqueous base fluid. The treatment fluid is introduced into a wellbore penetrating a subterranean formation. A mineral in the wellbore is contacted with the treatment fluid thereby preventing further mineral formation and deposition.

### TECHNICAL FIELD

The present disclosure relates generally to wellbore operations, and more particularly, to the use of a blend of phosphonate acids to prevent scale formation and particularly, scale formation in challenging wellbore environments such as those with high alkalinity and high CO₂ content.

### BACKGROUND

Natural resources such as gas, oil, and water residing in a subterranean formation may be recovered via flow into a wellbore from the subterranean formation. Recovery of these resources may be impeded by scale formation in some wellbore environments. Scale formation is the process of mineral deposition on wellbore surfaces and equipment. During the life of the wellbore, minerals may be freed from the formation and as the wellbore conditions change, so does the solubility of these freed minerals. Oversaturated minerals may precipitate and form scale on wellbore equipment and formation surfaces, and particularly on near wellbore formation surfaces. Scale may damage the formation and wellbore equipment as well as impact well productivity. Moreover, some wellbore environments, such as those having high alkalinity, high CO₂ content, or high temperatures, may impact the effectiveness of treatment with scale inhibitors. The prevention of scale formation may be important for maintaining stable and productive wellbore operations.

Scale prevention may be a necessary wellbore operation for some wells. The present disclosure provides improved treatment fluids for preventing the formation of scale in wellbore.

### BRIEF DESCRIPTION OF THE DRAWINGS

Illustrative examples of the present disclosure are described in detail below with reference to the attached drawing figures, which are incorporated by reference herein, and wherein:

FIG. 1 is an illustrative schematic of a system that can deliver examples of the treatment fluids to a downhole location in accordance with one or more examples described herein;

FIG. 2 is an illustrative schematic of a drilling assembly in which a drilling fluid containing the treatment fluid as a component part is used in accordance with one or more examples described herein;

FIG. 3 is an illustrative schematic of a hydraulic fracturing operation in which a fracturing fluid containing the treatment fluid as a component part is used in accordance with one or more examples described herein;

FIG. 4 is a graph illustrating the scale inhibitor performance of a phosphonate blend in accordance with one or more examples described herein;

FIG. 5 is a bar graph illustrating the minimum effective concentration values for experimental treatment fluids in accordance with one or more examples described herein;

FIG. 6 is a bar graph illustrating the synergistic effect on the minimum effective concentration obtained by increasing the concentration of the aminoethylethanolamine tri(methylene phosphonate) in the phosphonate blend in accordance with one or more examples described herein;

FIG. 7 is a graph illustrating the brine compatibility ranking of a phosphonate blend in accordance with one or more examples described herein;

FIG. 8 is a bar graph illustrating the compatibility ranking of FIG. 7 in accordance with one or more examples described herein; and

FIG. 9 is a photograph illustrating a synthetic brine compatibility test of a phosphonate blend in accordance with one or more examples described herein.

The illustrated figures are only exemplary and are not intended to assert or imply any limitation with regard to the environment, architecture, design, or process in which different examples may be implemented.

### DETAILED DESCRIPTION

The present disclosure relates generally to wellbore operations, and more particularly, to the use of a blend of phosphonate acids to prevent scale formation and particularly, scale formation in challenging wellbore environments such as those with high alkalinity and high CO₂ content.

In the following detailed description of several illustrative examples, reference is made to the accompanying drawings that form a part hereof, and in which is shown by way of illustration specific examples that may be practiced. These examples are described in sufficient detail to enable those skilled in the art to practice them, and it is to be understood that other examples may be utilized, and that logical structural, mechanical, electrical, and chemical changes may be made without departing from the spirit or scope of the disclosed examples. To avoid detail not necessary to enable those skilled in the art to practice the examples described herein, the description may omit certain information known to those skilled in the art. The following detailed description is, therefore, not to be taken in a limiting sense, and the scope of the illustrative examples are defined only by the appended claims.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present disclosure. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

In the following discussion and in the claims, the terms “including” and “comprising” are used in an open-ended fashion, and thus should be interpreted to mean “including, but not limited to.” Unless otherwise indicated, as used throughout this document, “or” does not require mutual exclusivity.

The terms “uphole” and “downhole” may be used to refer to the location of various components relative to the bottom or end of a well. For example, a first component described as uphole from a second component may be further away from the end of the well than the second component. Similarly, a first component described as being downhole from a second component may be located closer to the end of the well than the second component.

The terms “upstream” and “downstream” may be used to refer to the location of various components relative to one another in regards to the flow of a sample through said components. For example, a first component described as upstream from a second component will encounter a sample before the downstream second component encounters the sample. Similarly, a first component described as being downstream from a second component will encounter the sample after the upstream second component encounters the sample.

As used herein the weight/volume (“w/v”) is to be understood to mean the grams/milliliters and the weight/volume percentage (“% w/v”) is to be understood to mean the grams/milliliters multiplied by 100.

The present disclosure relates generally to wellbore operations, and more particularly, to the use of a blend of phosphonate acids to prevent scale formation and particularly, scale formation in challenging wellbore environments such as those with high alkalinity and high CO₂ content. Advantageously, the treatment fluid comprises a blend of phosphonate acids. The blend of phosphonate acids provides the treatment fluid the ability to prevent scale formation and deposition in specific wellbore environments such as those with high temperatures and high concentrations of CO₂. For example, using a blend of phosphonate acids allows for compatibility with brines having a high concentration of dissolved solids and with wellbore environments having significant CO₂ content (e.g., 50-100% of the pas phase) and high temperatures (e.g., 220° F.-450° F.), in the presence of scaling cations such as calcium, strontium, magnesium, and barium. A further advantage is that the treatment fluid successfully prevents the formation of troublesome scale species such as calcite scale. Moreover, the treatment fluid has low corrosivity as well as high formulation stability at elevated temperatures. A still further advantage is that the treatment fluid exhibits a synergistic effect where the blend of phosphonate acids exhibits a lower minimum effective concentration than would be expected based on the observed minimum effective concentration of the individual phosphonate acids. Additionally, it has been discovered that the addition of an organic acid at certain levels improves brine compatibility of the blend of phosphonate acids whilst able to avoid inducing corrosion tendency towards metallic parts of common downhole tools.

The treatment fluids comprise a phosphonate blend. One phosphonate used in the blend is aminoethylethanolamine tri(methylene phosphonate) (AEEA). AEEA may be used in the treatment fluid as a primary scale inhibitor. The AEEA may adsorb onto a growing scale crystal, disrupting further nucleation thereby preventing further scale formation and deposition. The AEEA may bind to a variety of scale species including carbonate scales such as calcite.

The concentration of AEEA in a treatment fluid may range from about 0.1% w/v to about 100% w/v. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of AEEA in the treatment fluid may range from about 0.1% (w/v) to about 100% (w/v), from about 0.5% (w/v) to about 100% (w/v), from about 1% (w/v) to about 100% (w/v), from about 2% (w/v) to about 100% (w/v), from about 3% (w/v) to about 100% (w/v), from about 4% (w/v) to about 100% (w/v), from about 5% (w/v) to about 100% (w/v), from about 6% (w/v) to about 100% (w/v), from about 7% (w/v) to about 100% (w/v), from about 8% (w/v) to about 100% (w/v), from about 9% (w/v) to about 100% (w/v), from about 10% (w/v) to about 100% (w/v), from about 20% (w/v) to about 100% (w/v), from about 30% (w/v) to about 100% (w/v), from about 40% (w/v) to about 100% (w/v), from about 50% (w/v) to about 100% (w/v), from about 60% (w/v) to about 100% (w/v), from about 70% (w/v) to about 100% (w/v), from about 80% (w/v) to about 100% (w/v), or from about 90% (w/v) to about 100% (w/v). As another example, the concentration of AEEA in the treatment fluid may range from about 0.1% (w/v) to about 100% (w/v), from about 0.1% (w/v) to about 90% (w/v), from about 0.1% (w/v) to about 80% (w/v), from about 0.1% (w/v) to about 70% (w/v), from about 0.1% (w/v) to about 60% (w/v), from about 0.1% (w/v) to about 50% (w/v), from about 0.1% (w/v) to about 40% (w/v), from about 0.1% (w/v) to about 30% (w/v), from about 0.1% (w/v) to about 20% (w/v), from about 0.1% (w/v) to about 10% (w/v), from about 0.1% (w/v) to about 9% (w/v), from about 0.1% (w/v) to about 8% (w/v), from about 0.1% (w/v) to about 7% (w/v), from about 0.1% (w/v) to about 6% (w/v), from about 0.1% (w/v) to about 5% (w/v), from about 0.1% (w/v) to about 4% (w/v), from about 0.1% (w/v) to about 3% (w/v), from about 0.1% (w/v) to about 2% (w/v), from about 0.1% (w/v) to about 1% (w/v), or from about 0.1% (w/v) to about 0.5% (w/v). With the benefit of this disclosure, one of ordinary skill in the art will be readily able to prepare a treatment fluid having a desirable concentration of AEEA for use in a given wellbore operation.

A second phosphonate used in the phosphonate blend is polyamino polyether methylene phosphonate (PAPEMP). PAPEMP may be used in the treatment fluid as a secondary scale inhibitor which may adsorb onto a growing scale crystal, disrupting further nucleation thereby preventing further scale formation and deposition. The PAPEMP may bind to a variety of scale species including carbonate scales such as calcite. Additionally, the PAPEMP improves the brine compatibility of the phosphonate blend. As alkalinity of the brine increases, or the total concentration of dissolved solids in the brine increases, the brine compatibility of the AEEA may be impacted. The inclusion of PAPEMP improves compatibility of the phosphonate blend in brines having high alkalinity and total dissolved solids.

The concentration of PAPEMP in a treatment fluid may range from about 0.1% w/v to about 100% w/v. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of PAPEMP in the treatment fluid may range from about 0.1% (w/v) to about 100% (w/v), from about 0.5% (w/v) to about 100% (w/v), from about 1% (w/v) to about 100% (w/v), from about 2% (w/v) to about 100% (w/v), from about 3% (w/v) to about 100% (w/v), from about 4% (w/v) to about 100% (w/v), from about 5% (w/v) to about 100% (w/v), from about 6% (w/v) to about 100% (w/v), from about 7% (w/v) to about 100% (w/v), from about 8% (w/v) to about 100% (w/v), from about 9% (w/v) to about 100% (w/v), from about 10% (w/v) to about 100% (w/v), from about 20% (w/v) to about 100% (w/v), from about 30% (w/v) to about 100% (w/v), from about 40% (w/v) to about 100% (w/v), from about 50% (w/v) to about 100% (w/v), from about 60% (w/v) to about 100% (w/v), from about 70% (w/v) to about 100% (w/v), from about 80% (w/v) to about 100% (w/v), or from about 90% (w/v) to about 100% (w/v). As another example, the concentration of PAPEMP in the treatment fluid may range from about 0.1% (w/v) to about 100% (w/v), from about 0.1% (w/v) to about 90% (w/v), from about 0.1% (w/v) to about 80% (w/v), from about 0.1% (w/v) to about 70% (w/v), from about 0.1% (w/v) to about 60% (w/v), from about 0.1% (w/v) to about 50% (w/v), from about 0.1% (w/v) to about 40% (w/v), from about 0.1% (w/v) to about 30% (w/v), from about 0.1% (w/v) to about 20% (w/v), from about 0.1% (w/v) to about 10% (w/v), from about 0.1% (w/v) to about 9% (w/v), from about 0.1% (w/v) to about 8% (w/v), from about 0.1% (w/v) to about 7% (w/v), from about 0.1% (w/v) to about 6% (w/v), from about 0.1% (w/v) to about 5% (w/v), from about 0.1% (w/v) to about 4% (w/v), from about 0.1% (w/v) to about 3% (w/v), from about 0.1% (w/v) to about 2% (w/v), from about 0.1% (w/v) to about 1% (w/v), or from about 0.1% (w/v) to about 0.5% (w/v). With the benefit of this disclosure, one of ordinary skill in the art will be readily able to prepare a treatment fluid having a desirable concentration of PAPEMP for use in a given wellbore operation.

The proportion of AEEA and PAPEMP in the treatment fluid may impact the compatibility of the phosphonate blend in some species of the aqueous base fluid, for example, in brines having a high dissolved solids content or a high alkalinity. In some examples, the ratio of AEEA to PAPEMP in the treatment fluid is in a range of about 3:1 to about 1:3. In a preferred example, the ratio of AEEA to PAPEMP is 1:1.

The treatment fluids described herein comprise an organic acid. The organic acid may be used to improve brine compatibility of the phosphonate blend. Examples of the organic acid include, but are not limited to, acetic acid, formic acid, citric acid, lactic acid, glycolic acid, oxalic acid, salicylic acid, butyric acid, propionic acid, succinic acid, fumaric acid, uric acid, malic acid, tartaric acid, allaric acid, altaric acid, altraric acid, altronic acid, arabinaric acid, arabinonic acid, dihomocitric acid, fructuronic acid, fuconic acid, galactaric acid, galactonic acid, galacturonic acid, glucaric acid, glucoheptonic acid, gluconic acid, glucuronic acid, gulonic acid, homocitric acid, homoisocitric acid, idaric acid, idonic acid, iduronic acid, isocitric acid, mannaric acid, mannonic acid, octulosonic acid, rhamnonic acid, ribonic acid, tagaturonic acid, xylonic acid, or xyluronic acid, or a salt or derivative thereof, or a combination thereof, or any combination of organic acids.

The concentration of the organic acid in the treatment fluid may range from about 0.1% w/v to about 25% w/v. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the organic acid in the treatment fluid may range from about 0.1% (w/v) to about 25% (w/v), from about 0.5% (w/v) to about 25% (w/v), from about 1% (w/v) to about 25% (w/v), from about 2% (w/v) to about 25% (w/v), from about 3% (w/v) to about 25% (w/v), from about 4% (w/v) to about 25% (w/v), from about 5% (w/v) to about 25% (w/v), from about 6% (w/v) to about 25% (w/v), from about 7% (w/v) to about 25% (w/v), from about 8% (w/v) to about 25% (w/v), from about 9% (w/v) to about 25% (w/v), from about 10% (w/v) to about 25% (w/v), from about 15% (w/v) to about 25% (w/v), or from about 20% (w/v) to about 25% (w/v). As another example, the concentration of the organic acid in the treatment fluid may range from about 0.1% (w/v) to about 10% (w/v), from about 0.1% (w/v) to about 9% (w/v), from about 0.1% (w/v) to about 8% (w/v), from about 0.1% (w/v) to about 7% (w/v), from about 0.1% (w/v) to about 6% (w/v), from about 0.1% (w/v) to about 5% (w/v), from about 0.1% (w/v) to about 4% (w/v), from about 0.1% (w/v) to about 3% (w/v), from about 0.1% (w/v) to about 2% (w/v), from about 0.1% (w/v) to about 1% (w/v), or from about 0.1% (w/v) to about 0.5% (w/v). With the benefit of this disclosure, one of ordinary skill in the art will be readily able to prepare and select an organic acid having a desirable concentration for use in a given treatment fluid.

The treatment fluids described herein comprise an aqueous base fluid, for example, freshwater, saltwater (e.g., water containing one or more salts dissolved therein), brine (e.g., saturated saltwater, including saturated saltwater produced from subterranean formations), seawater, desulphated seawater, or any combination thereof. Generally, the aqueous base fluid may be from any source provided that the aqueous base fluid does not contain an excess of compounds that may undesirably affect other components in the treatment fluid. In the case of brines, the aqueous base fluid may comprise a monovalent brine or a divalent brine. Suitable monovalent brines may include, for example, sodium chloride brines, sodium bromide brines, potassium chloride brines, potassium bromide brines, ammonium chloride brines, and the like. Suitable divalent brines can include, for example, barium chloride brines, zinc chloride brines, manganese chloride brines, manganese oxide brines, calcium bromide brines, magnesium chloride brines, calcium chloride brines, and the like.

The concentration of the aqueous base fluid in the treatment fluid may range from about 1% (w/v) to about 99% (w/v). The concentration of the aqueous base fluid in the treatment fluid may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the aqueous base fluid in the treatment fluid may range from about 1% (w/v) to about 99% (w/v), from about 5% (w/v) to about 99% (w/v), from about 10% (w/v) to about 99% (w/v), from about 15% (w/v) to about 99% (w/v), from about 20% (w/v) to about 99% (w/v), from about 25% (w/v) to about 99% (w/v), from about 30% (w/v) to about 99% (w/v), from about 35% (w/v) to about 99% (w/v), from about 40% (w/v) to about 99% (w/v), from about 45% (w/v) to about 99% (w/v), from about 55% (w/v) to about 99% (w/v), from about 60% (w/v) to about 99% (w/v), from about 65% (w/v) to about 99% (w/v), from about 70% (w/v) to about 99% (w/v), from about 75% (w/v) to about 99% (w/v), from about 80% (w/v) to about 99% (w/v), from about 85% (w/v) to about 99% (w/v), from about 90% (w/v) to about 99% (w/v), or from about 95% (w/v) to about 99% (w/v). As another example, the concentration of the aqueous base fluid in the treatment fluid may range from about 1% (w/v) to about 99% (w/v), from about 1% (w/v) to about 95% (w/v), from about 1% (w/v) to about 90% (w/v), from about 1% (w/v) to about 85% (w/v), from about 1% (w/v) to about 80% (w/v), from about 1% (w/v) to about 75% (w/v), from about 1% (w/v) to about 70% (w/v), from about 1% (w/v) to about 65% (w/v), from about 1% (w/v) to about 60% (w/v), from about 1% (w/v) to about 55% (w/v), from about 1% (w/v) to about 50% (w/v), from about 1% (w/v) to about 45% (w/v), from about 1% (w/v) to about 40% (w/v), from about 1% (w/v) to about 35% (w/v), from about 1% (w/v) to about 30% (w/v), from about 1% (w/v) to about 25% (w/v), from about 1% (w/v) to about 20% (w/v), from about 1% (w/v) to about 15% (w/v), from about 1% (w/v) to about 10% (w/v), or from about 1% (w/v) to about 5% (w/v). With the benefit of this disclosure, one of ordinary skill in the art will be able to prepare a treatment fluid having a sufficient concentration of an aqueous base fluid for a given application.

In some optional examples, the treatment fluids may further comprise an additional additive. The additional additive may be used to adjust a property of the treatment fluid, for example, viscosity, density, etc. Examples of the additives include, but are not limited to, silica scale control additives, corrosion inhibitors, surfactants, gel stabilizers, anti-oxidants, polymer degradation prevention additives, relative permeability modifiers, scale inhibitors, iron control agents, particulate diverters, salts, fluid loss control additives, gas, catalysts, clay control agents, dispersants, flocculants, scavengers (e.g., H₂S scavengers, CO₂ scavengers or O₂ scavengers), gelling agents, lubricants, friction reducers, bridging agents, viscosifiers, weighting agents, solubilizers, hydrate inhibitors, consolidating agents, bactericides, clay stabilizers, breakers, delayed release breakers, the like, or any combination thereof. With the benefit of this disclosure, one of ordinary skill in the art and the benefit of this disclosure will be able to formulate a treatment fluid having properties suitable for a desired application.

The aqueous base fluid may be a brine that is alkaline and comprises a high concentration of total dissolved solids. These species of aqueous base fluids may produce a treatment fluid that is also alkaline and comprises a high concentration of total dissolved solids. In some examples, the concentration of the total dissolved solids may range from about 500 ppm to about 10,000 ppm. In some examples, the treatment fluid may comprise a concentration of total dissolved solids in a range of about 1000 ppm to about 2000 ppm. In some examples, the pH of the treatment fluid, as measured prior to contact with any downhole fluids, may be in a range of about 4 to about 8.

The treatment fluids may be used in wellbores and subterranean formations having a variety of temperatures. By way of example, the wellbores and subterranean formations may have a temperature in a range of about 100° F. to about 450° F. The treatment fluid may prevent the formation of scale while being exposed to temperatures in the aforementioned range.

In some examples, the treatment fluid may be used in wellbores having a significant amount of CO₂ content. The CO₂ content may be indicative of the potential for scale formation, and in particular carbonate scale formation. Pressure, volume, and temperature analysis of the total fluids in these well systems may be conducted. The total fluid measurement measures the gases, liquids, and sometimes solids in the produced wellbore fluids. For scaling analysis, the CO₂ percentage is in the gas phase under downhole conditions, but the gas volume will be less and the CO₂ will be more dissolved in any downhole fluids including the example treatment fluids described herein. In a specific example, the treatment fluid may be used in a wellbore where a produced fluid from the wellbore has a measurable CO₂ concentration of about 50% to about 100% of the gas phase of the produced fluid. A produced fluid having a CO₂ concentration in this range for the gas phase may indicate a well system having a potential for carbonate scaling.

An example use of the treatment fluid includes introducing the treatment fluid into a wellbore. For example, the treatment fluid may be injected through a downhole injection point into the wellbore to contact a mineral, such as those minerals which may form scale. The mineral may be disposed on a piece of downhole wellbore equipment or may be located on the wellbore wall of within the subterranean formation. In some further examples, the treatment fluid may be used to treat wellbore equipment and the treatment fluid may be contained primarily in the wellbore. In other examples, the treatment fluid may be placed in the subterranean formation for subsequent commingling with any formation fluids as they are produced.

The treatment fluid may be used to inhibit the formation of a variety of scale species. Of particular importance are scale species formed from calcium carbonate, which may be referred to as carbonate scaling. More specifically, the treatment fluid may be used to inhibit the formation of calcite scale which is a type of carbonate scaling common to some wellbore environments. The treatment fluids may also be used to inhibit the formation of other carbonate scale species, such as aragonite and vaterite scale.

In a specific example, the treatment fluid may be introduced into the wellbore through wellbore tubing or conduits by application of sufficient pressure from the surface to place the treatment fluid into the targeted wellbore zone. If the treatment fluid is to remain primarily in the wellbore, the downhole injection pressure may be less than the formation fracturing pressure. The treatment fluid may be added in a single injection or it may be added to the wellbore continuously.

In another example, the treatment fluid may be used in a squeeze operation. The treatment fluid is injected down the wellbore into the wellbore annulus. Optionally, a flush fluid may be subsequently injected to squeeze the treatment fluid into the subterranean formation. The injection of the treatment fluid may continue until the desired volume of treatment fluid has been injected. After injection, production may be resumed through the normal downhole flow of fluids through a wellbore tubular or conduit and then up the wellbore annulus. Optionally, a pump may be used to inject additional treatment fluid into the wellbore on a continuous or intermittent basis.

An example use of the treatment fluid combines the treatment fluid with a drilling fluid to provide scale inhibition while drilling a production interval in a wellbore. The treatment fluid provides scale inhibition to the wellbore equipment as well as the surrounding wellbore walls during the drilling operation. The treatment fluid may be used continuously with the drilling fluid or added intermittently as desired.

One additional use of the treatment fluid combines the treatment fluid with a fracturing fluid. During hydraulic fracturing, a fracturing fluid is injected into a wellbore under high pressure causing fractures to open around the wellbore and into the subterranean formation. The treatment fluid may adsorb on to the matrix surrounding the fracture face during the fracturing operation. The treatment fluid may be combined with any type of fracturing fluid. The treatment fluid may be used to contact mineral-containing formation fluids exiting the fracture before these fluids enter the wellbore and begin to promote scale formation.

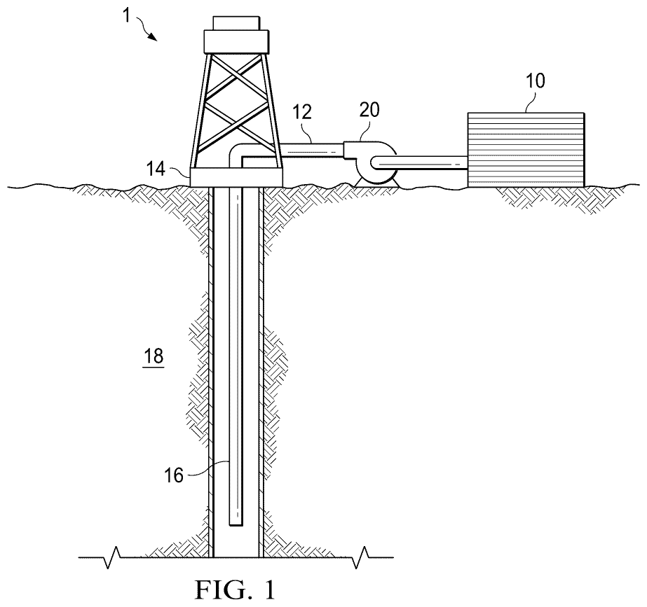

FIG. 1 shows an illustrative schematic of a system that can deliver examples of the treatment fluids to a downhole location. It should be noted that while FIG. 1 generally depicts a land-based system, it is to be recognized that like systems can be operated in subsea locations as well. As depicted in FIG. 1, a system 1 comprises a mixing tank 10, in which the treatment fluids described herein may be formulated. The components of the treatment fluid, for example, the AEEA, the PAPEMP, the organic acid, and the aqueous base fluid may be combined with one another in any order. Once mixed and prepared, the treatment fluids are then conveyed into the wellbore via a line 12 to the wellhead 14, where the treatment fluid enters a tubular 16, with the tubular 16 extending from the wellhead 14 into a subterranean formation 18. At a desired location, the treatment fluid is ejected from the tubular 16 to begin inhibiting scale formation on wellbore equipment and wellbore surfaces.

The pump 20 can be configured to raise the pressure of the treatment fluid to a desired degree before its introduction into the tubular 16. It is to be recognized that the system 1 is merely exemplary in nature and various additional components can be present that have not necessarily been depicted in FIG. 1 in the interest of clarity. Non-limiting additional components that can be present include, but are not limited to, supply hoppers, valves, condensers, adapters, joints, gauges, sensors, compressors, pressure controllers, pressure sensors, flow rate controllers, flow rate sensors, temperature sensors, and the like.

In some alternative examples, the treatment fluid may be introduced in a squeeze operation in the annular region surrounding the tubular 16. Optionally, a flush fluid may be introduced subsequently to the treatment fluid to squeeze the treatment fluid into the surrounding subterranean formation 18. After completion of the squeeze operation, the normal method of fluid injection down tubular 16 may be resumed.

It should be clearly understood that the example system illustrated by FIG. 1 is merely a general application of the principles of this disclosure in practice, and a wide variety of other examples are possible. Therefore, the scope of this disclosure is not limited in any manner to the details of FIG. 1 as described herein.

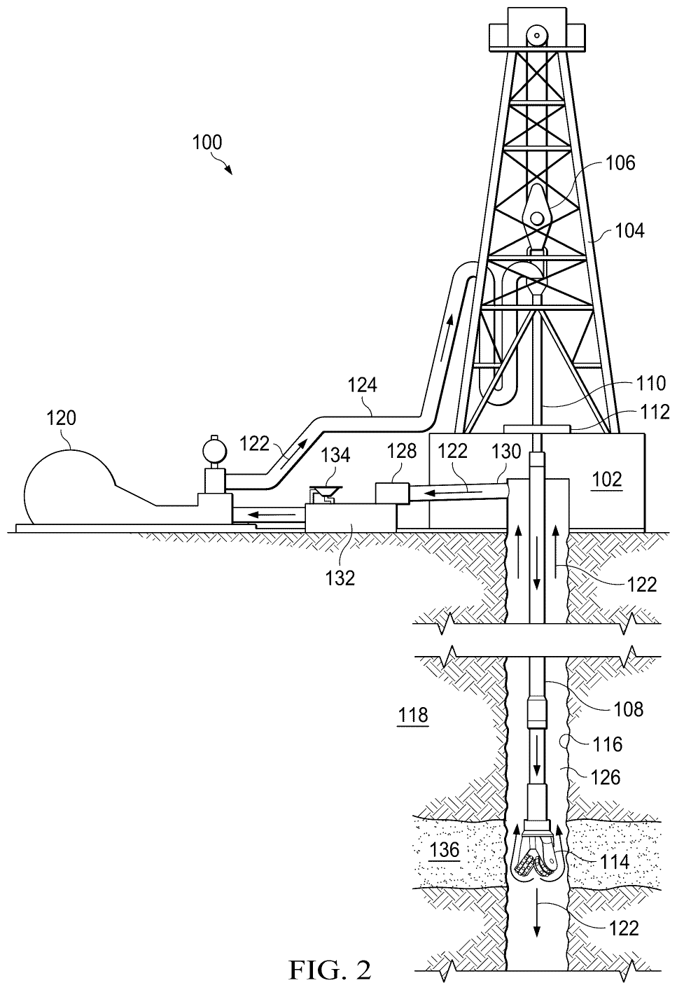

FIG. 2 illustrates a schematic of a drilling assembly 100 in which a drilling fluid 122 may be used. It should be noted that while FIG. 2 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 may support the drill string 108 as it is lowered through a rotary table 112. A drill bit 114 may be attached to the distal end of the drill string 108 and may be driven either by a downhole motor and/or via rotation of the drill string 108 from the well surface. The drill bit 114 may include, but is not limited to, roller cone bits, PDC bits, natural diamond bits, any hole openers, reamers, coring bits, etc. As the drill bit 114 rotates, it may create a wellbore 116 that penetrates various subterranean formations 118. In an embodiment, the drill bit 114 may penetrate reservoir section 136 and a drilling fluid 122, as disclosed herein, may be circulated in the wellbore 116 during the drilling of the reservoir section 136.

The drilling fluid 122 comprises a treatment fluid, as described herein, as one of its component parts. A pump 120 (e.g., a mud pump) may circulate the drilling fluid 122 through a feed pipe 124 and to the kelly 110, which conveys the drilling fluid 122 downhole through the interior of the drill string 108 and through one or more orifices in the drill bit 114 and into the wellbore 116 portion penetrating the reservoir section 136. The treatment fluid portion of the drilling fluid 122 may then contact a mineral located on the wellbore equipment or on a subterranean formation surface to prevent further scale formation and deposition.

The drilling fluid 122 may then be circulated back to the surface via an annulus 126 defined between the drill string 108 and the walls of the wellbore 116. At the surface, the recirculated or spent drilling fluid 122 may exit the annulus 126 and may be conveyed to one or more fluid processing unit(s) 128 via an interconnecting flow line 130. The fluid processing unit(s) 128 may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, and/or any fluid reclamation equipment. The fluid processing unit(s) 128 may further include one or more sensors, gauges, pumps, compressors, and the like used store, monitor, regulate, and/or recondition the drilling fluid 122.

After passing through the fluid processing unit(s) 128, a “cleaned” drilling fluid 122 may be deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure. One or more drilling fluid additives may be added to the drilling fluid 122 via a mixing hopper 134 communicably coupled to or otherwise in fluid communication with the retention pit 132. In some examples, the drilling fluid additives comprise additional amounts of the treatment fluid components (e.g., the AEEA, PAPEMP, organic acid, etc.) that may be added to the drilling fluid 122 via the mixing hopper. The mixing hopper 134 may include, but is not limited to, mixers and related mixing equipment known to those skilled in the art. Alternatively, the drilling fluid additives may be added to the drilling fluid 122 at any other location in the drilling assembly 100. While FIG. 2 shows only a single retention pit 132, there could be more than one retention pit 132, such as multiple retention pits 132 in series. Moreover, the retention pit 132 may be representative of one or more fluid storage facilities and/or units where the drilling fluid additives may be stored, reconditioned, and/or regulated until added to the drilling fluid 122.

It should be clearly understood that the example system illustrated by FIG. 2 is merely a general application of the principles of this disclosure in practice, and a wide variety of other examples are possible. Therefore, the scope of this disclosure is not limited in any manner to the details of FIG. 2 as described herein.

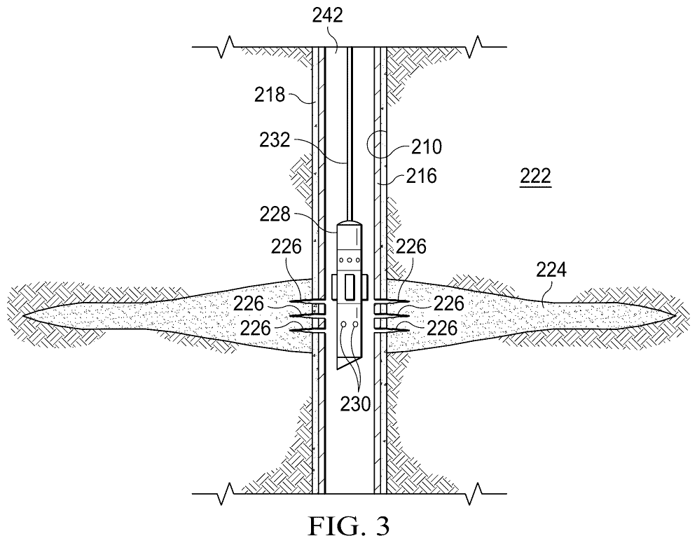

FIG. 3 is a schematic illustrating the placing of the treatment fluids described herein within a fracture of a subterranean formation. In a hydraulic fracturing operation, a fracture 224 is formed in a subterranean formation 222 of the wellbore 210. To initiate the operation, perforations 226 are made that penetrate through the casing 216, the cement sheath 218, and into the subterranean formation 222. In this example, the treatment fluid is a component part of a fracturing fluid. The treatment fluid, as a part of the fracturing fluid, is introduced into the fractured portion of the subterranean formation 222 through the perforations 226. While the subterranean formation 222 may be perforated using any suitable technique, the present example utilizes a jetting tool 228. The jetting tool 228 may be any suitable assembly for use in subterranean operations through which a fluid may be jetted at high pressures. By way of example, when used to form the perforations 226, the jetting tool 228 should be configured to jet a fluid against the casing 216 and the cement sheath 218 such that perforations 226 may be formed. As illustrated, the jetting tool 228 may contain ports 230 for discharging a fluid from the jetting tool 228.

In operation, the jetting tool 228 may be positioned in the wellbore 210 adjacent the portion of the wellbore 210 where fracture formation is desired. As illustrated, the jetting tool 228 may be coupled to a work string 232 (e.g., piping, coiled tubing, etc.) and lowered into the wellbore 210 to the desired position. Once the jetting tool 228 has been so positioned, a fluid may be pumped down through the work string 232, into the jetting tool 228, out through the ports 230, and against the interior surface of the casing 216 causing perforations 226 to be formed through the casing 216 and the cement sheath 218.

In accordance with the examples described herein, the fracturing fluid may be introduced into the fracture 224 via the jetting tool 228 or other such delivery tool. As the treatment fluid is injected into the fracture 224, it will flow into the fracture and contact scale-forming minerals within thereby preventing scale formation by these minerals as they are flowed into the adjacent wellbore.

Alternative wellbore tools for introduction of the treatment fluid may include, but are not limited to, bull heading, coil tubing, or jointed pipe (e.g., with straddle packers, jetting tools, etc.). In the present example, the treatment fluid is injected into the fracture 224 by the jetting tool 228 while the jetting tool 228 is still in position in the wellbore 210. Utilization of the jetting tool 228 may reduce the need for equipment, such as packers, to isolate the treated formation interval. Alternatively, the treatment fluid may be injected through the annulus 242 between the work string 232 and the casing 216.

It should be clearly understood that the example system illustrated by FIG. 3 is merely a general application of the principles of this disclosure in practice, and a wide variety of other examples are possible. Therefore, the scope of this disclosure is not limited in any manner to the details of FIG. 3 as described herein.

To facilitate a better understanding of the present embodiments, the following examples of certain aspects of some embodiments are given. In no way should the following examples be read to limit, or define, the entire scope of the embodiments.

### Examples

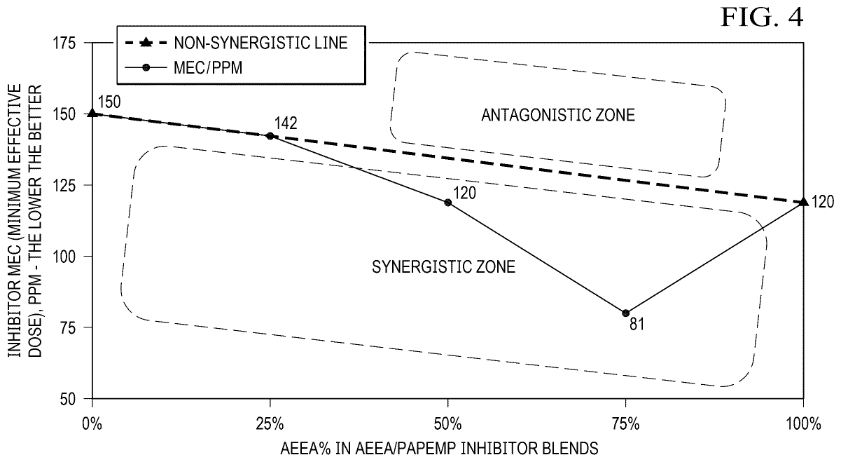

FIG. 4 illustrates a graph of the scale inhibitor performance, and more specifically the minimum effective concentration (MEC) that was measured by performing a dynamic scaling loop for the phosphonate blends. A set of synthetic brines (anion water and cation water) was prepared for measurement having the dissolved solids shown below in Table 1, a 50% CO₂ content for the gas phase, and a measurement temperature of 300° F. When mixed in a 1:1 ratio the anion water and cation water reconstitute the analog water. The anion and cation components were heated through separate heat exchange tubes in a heated oven. The heated components entered a mixing tee where the mixture immediately ran through a three-foot-long capillary tube with an inner diameter of 0.75 millimeter. The flow rate of the scaling brine was fixed at 10 ml/min (5 ml/min for each pump). The pH of the scaling brine was controlled by purging the anion and cation brines with 50% CO₂ gas for at least 30 minutes before the testing. The differential pressure across this capillary tube was measured while the scaling brine passed at a constant flow rate. An increase in differential pressure indicates that solids were forming in the tube and adhering to the walls.

Once the brines were prepared and conditions set, the equipment would run until the test period time elapsed (maximum 60 minutes), or a set differential pressure (dP increase of 0.5+ psi) was reached. An observation of 0.5+ dp increase during the test period indicates a failure at that concentration, while a stable dp curve during the test period suggests a pass at the dose rate. The MEC is the lowest tested concentration for the loop testing to be passed. The tube was cleaned using an acid and/or chelator, and the process was repeated at a different concentration and/or with a different inhibitor. All test chemicals were added to the anionic brine.

The minimum effective concentration for scale inhibition under field conditions was previously determined to be 150 ppm for a sample of PAPEMP and 120 ppm for a sample of AEEA. The red line in the graph represents the expected MECs when these two chemistries are mixed, with the green zone indicating a synergistic effect and the red zone indicating antagonism. The results show that the synergistic effect is significant for a 1:1 mix but reaches its maximum at a 3:1 mix of AEEA to PAPEMP.

TABLE 1
Synthetic brine tested.

| Species | Field representative brine for testing (ppm) |
|---|---|
| Na⁺ | 2,404 |
| Mg²⁺ | 24 |
| Ca²⁺ | 950 |
| HCO₃⁻ | 1,320 |
| SO₄²⁻ | 132 |
| Cl⁻ | 4,600 |
| CO₂ % | 50% |

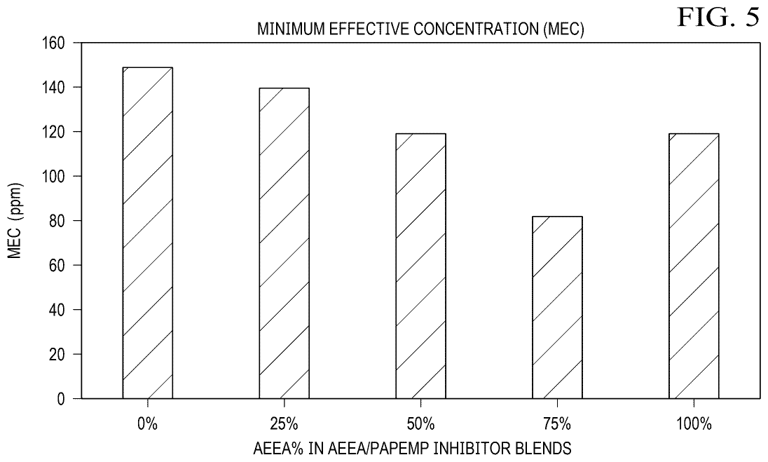

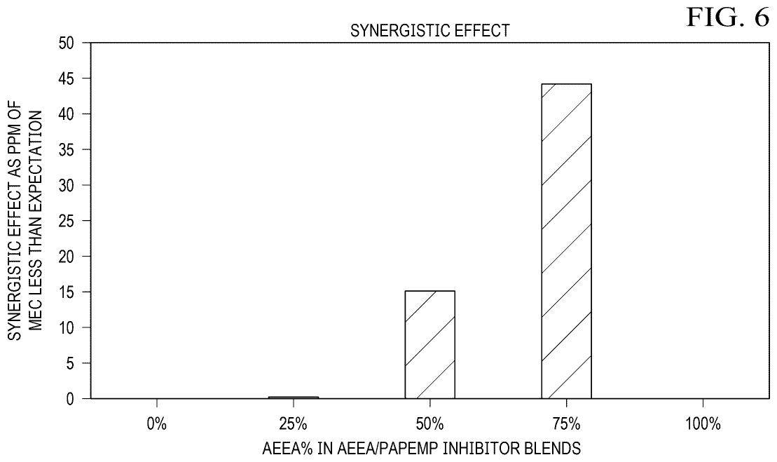

FIG. 5 is a bar graph illustrating the MEC values and FIG. 6 is a bar graph illustrating the synergistic effect on the MEC obtained by increasing the concentration of the AEEA in the phosphonate blend.

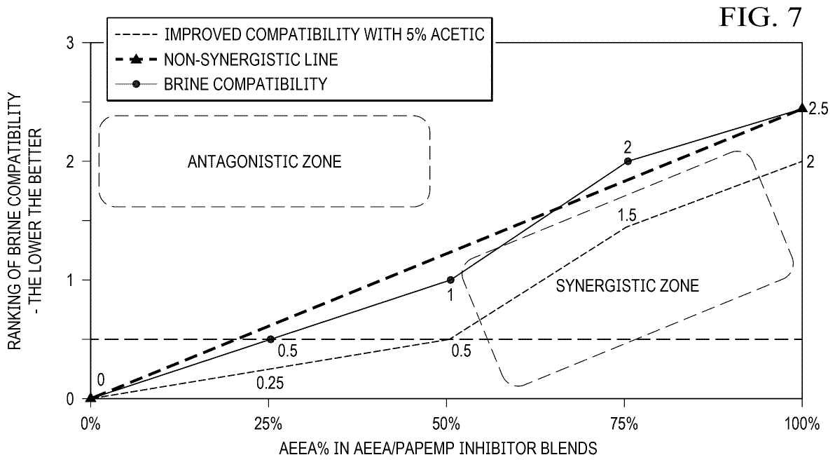

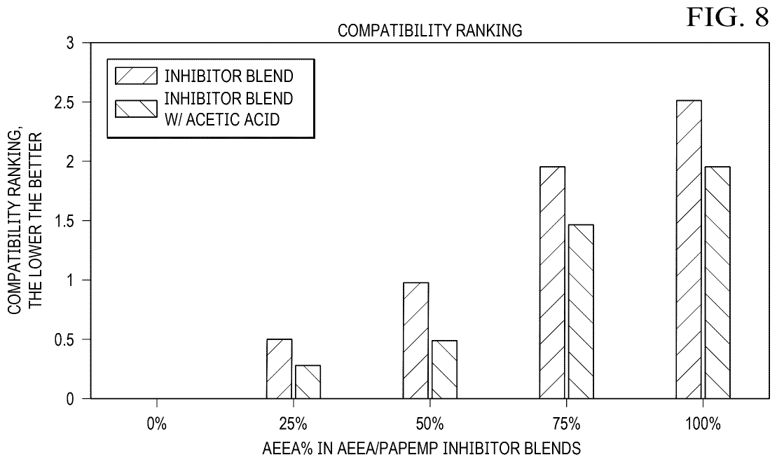

In FIG. 7, the brine compatibility of the phosphonate blends was measured. A synthetic brine as shown in Table 1 was prepared for measurement. This brine has a 50% CO₂ content for the gas phase and a measurement temperature of 180° F. A higher percentage of AEEA in the formulation resulted in less brine compatibility. Therefore, increasing the amount of PAPEMP in the phosphonate blend resulted in improved brine compatibility. FIG. 8 is a bar graph illustrating the compatibility ranking.

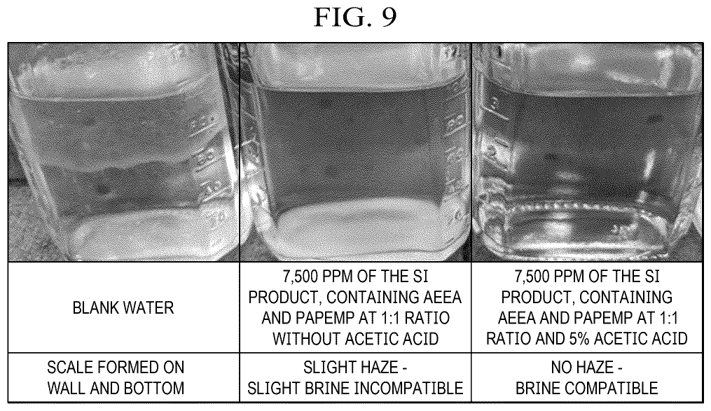

FIG. 9 is a photograph illustrating the brine compatibility of the phosphonate blends. A synthetic brine as shown in Table 1 was prepared. This brine has a 50% CO₂ content for the gas phase and a measurement temperature of 180° F. A 1:1 ratio of AEEA to PAPEMP for the phosphonate blend significantly improved brine compatibility, but minor pseudo-precipitation may still occur at high dosages as shown in the second photo. A small percentage (5%) of acetic acid was introduced and found to enhance performance, bringing the phosphonate blend into the optimal acceptance range under stressed conditions as shown in the third photo.

The treatment fluids disclosed herein may directly or indirectly affect one or more components or pieces of equipment associated with or which may come into contact with the treatment fluids such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

Provided are treatment fluids for preventing the formation of scale in accordance with the disclosure and the illustrated FIGs. An example treatment fluid comprises polyamino polyether methylene phosphonate (PAPEMP), aminoethylethanolamine tri(methylene phosphonate) (AEEA), an organic acid, and an aqueous base fluid.

Additionally or alternatively, the treatment fluids may include one or more of the following features individually or in combination. The PAPEMP may be present in the treatment fluid in a concentration in a range of about 0.1% w/v to about 100% w/v. The AEEA may be present in the treatment fluid in a concentration in a range of about 0.1% w/v to about 100% w/v. The ratio of AEEA to PAPEMP in the treatment fluid may be in a range of about 3:1 to about 1:3. The organic acid may be selected from the group consisting of acetic acid, formic acid, citric acid, lactic acid, glycolic acid, oxalic acid, salicylic acid, butyric acid, propionic acid, succinic acid, fumaric acid, uric acid, malic acid, tartaric acid, allaric acid, altaric acid, altraric acid, altronic acid, arabinaric acid, arabinonic acid, dihomocitric acid, fructuronic acid, fuconic acid, galactaric acid, galactonic acid, galacturonic acid, glucaric acid, glucoheptonic acid, gluconic acid, glucuronic acid, gulonic acid, homocitric acid, homoisocitric acid, idaric acid, idonic acid, iduronic acid, isocitric acid, mannaric acid, mannonic acid, octulosonic acid, rhamnonic acid, ribonic acid, tagaturonic acid, xylonic acid, or xyluronic acid, a salt or derivative thereof, and a combination thereof. The organic acid may be present in the treatment fluid in a concentration in a range of about 0.1% w/v to about 25% w/v. The aqueous base fluid may be a brine having a dissolved solids content of 10,000 ppm or less.

Provided are methods for preventing the formation of scale with a treatment fluid in accordance with the disclosure and the illustrated FIGs. An example method comprises providing a treatment fluid comprising: polyamino polyether methylene phosphonate (PAPEMP), aminoethylethanolamine tri(methylene phosphonate) (AEEA), an organic acid, and an aqueous base fluid. The method further comprises introducing the treatment fluid into a wellbore penetrating a subterranean formation and contacting a mineral in the wellbore with the treatment fluid thereby preventing further mineral formation and deposition.

Additionally or alternatively, the method may include one or more of the following features individually or in combination. The mineral may be a carbonate scale. The carbonate scale may be calcite. The location of the mineral in the wellbore may have a temperature in a range of about 220° F. to about 450° F. The method may further comprise producing a fluid from the wellbore; wherein the produced fluid has a measurable CO₂ concentration of about 50% to about 100% of the gas phase of the produced fluid. The mineral may be disposed on a piece of wellbore equipment located in the wellbore. The PAPEMP may be present in the treatment fluid in a concentration in a range of about 0.1% w/v to about 100% w/v. The AEEA may be present in the treatment fluid in a concentration in a range of about 0.1% w/v to about 100% w/v. The ratio of AEEA to PAPEMP in the treatment fluid may be in a range of about 3:1 to about 1:3. The organic acid may be selected from the group consisting of acetic acid, formic acid, citric acid, lactic acid, glycolic acid, oxalic acid, salicylic acid, butyric acid, propionic acid, succinic acid, fumaric acid, uric acid, malic acid, tartaric acid, allaric acid, altaric acid, altraric acid, altronic acid, arabinaric acid, arabinonic acid, dihomocitric acid, fructuronic acid, fuconic acid, galactaric acid, galactonic acid, galacturonic acid, glucaric acid, glucoheptonic acid, gluconic acid, glucuronic acid, gulonic acid, homocitric acid, homoisocitric acid, idaric acid, idonic acid, iduronic acid, isocitric acid, mannaric acid, mannonic acid, octulosonic acid, rhamnonic acid, ribonic acid, tagaturonic acid, xylonic acid, or xyluronic acid, a salt or derivative thereof, and a combination thereof. The organic acid may be present in the treatment fluid in a concentration in a range of about 0.1% w/v to about 25% w/v. The aqueous base fluid may be a brine having a dissolved solids content of 10,000 ppm or less.

Provided are systems for preventing the formation of scale with a treatment fluid in accordance with the disclosure and the illustrated FIGs. An example system comprises a treatment fluid comprising: polyamino polyether methylene phosphonate (PAPEMP), aminoethylethanolamine tri(methylene phosphonate) (AEEA), an organic acid, and an aqueous base fluid. The system further comprises mixing equipment configured to mix the PAPEMP, AEEA, organic acid, and aqueous base fluid, and pumping equipment configured to pump the treatment fluid into a wellbore.

Additionally or alternatively, the system may include one or more of the following features individually or in combination. The system may further comprise a wellbore conduit. The pumping equipment and treatment fluid may be configured such that the treatment fluid contacts the wellbore conduit while the wellbore conduit is in the wellbore. The wellbore conduit may comprise a mineral disposed on a surface of the wellbore conduit. The mineral may be a carbonate scale. The carbonate scale may be calcite. The location of the mineral in the wellbore may have a temperature in a range of about 220° F. to about 450° F. The mineral may be disposed on a piece of wellbore equipment located in the wellbore. The PAPEMP may be present in the treatment fluid in a concentration in a range of about 0.1% w/v to about 100% w/v. The AEEA may be present in the treatment fluid in a concentration in a range of about 0.1% w/v to about 100% w/v. The ratio of AEEA to PAPEMP in the treatment fluid may be in a range of about 3:1 to about 1:3. The organic acid may be selected from the group consisting of acetic acid, formic acid, citric acid, lactic acid, glycolic acid, oxalic acid, salicylic acid, butyric acid, propionic acid, succinic acid, fumaric acid, uric acid, malic acid, tartaric acid, allaric acid, altaric acid, altraric acid, altronic acid, arabinaric acid, arabinonic acid, dihomocitric acid, fructuronic acid, fuconic acid, galactaric acid, galactonic acid, galacturonic acid, glucaric acid, glucoheptonic acid, gluconic acid, glucuronic acid, gulonic acid, homocitric acid, homoisocitric acid, idaric acid, idonic acid, iduronic acid, isocitric acid, mannaric acid, mannonic acid, octulosonic acid, rhamnonic acid, ribonic acid, tagaturonic acid, xylonic acid, or xyluronic acid, a salt or derivative thereof, and a combination thereof. The organic acid may be present in the treatment fluid in a concentration in a range of about 0.1% w/v to about 25% w/v. The aqueous base fluid may be a brine having a dissolved solids content of 10,000 ppm or less.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps. The systems and methods can also “consist essentially of or “consist of the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited. In the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

One or more illustrative examples incorporating the examples disclosed herein are presented. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

What is claimed is:

1. A treatment fluid for preventing the formation of scale, the treatment fluid comprises:
polyamino polyether methylene phosphonate (PAPEMP),
aminoethylethanolamine tri(methylene phosphonate) (AEEA),
an organic acid, and
an aqueous base fluid.

2. The treatment fluid of claim 1, wherein the PAPEMP is present in the treatment fluid in a concentration in a range of about 0.1% w/v to about 100% w/v.

3. The treatment fluid of claim 1, wherein the AEEA is present in the treatment fluid in a concentration in a range of about 0.1% w/v to about 100% w/v.

4. The treatment fluid of claim 1, wherein the ratio of AEEA to PAPEMP in the treatment fluid is in a range of about 3:1 to about 1:3.

5. The treatment fluid of claim 1, wherein the organic acid is selected from the group consisting of acetic acid, formic acid, citric acid, lactic acid, glycolic acid, oxalic acid, salicylic acid, butyric acid, propionic acid, succinic acid, fumaric acid, uric acid, malic acid, tartaric acid, allaric acid, altaric acid, altraric acid, altronic acid, arabinaric acid, arabinonic acid, dihomocitric acid, fructuronic acid, fuconic acid, galactaric acid, galactonic acid, galacturonic acid, glucaric acid, glucoheptonic acid, gluconic acid, glucuronic acid, gulonic acid, homocitric acid, homoisocitric acid, idaric acid, idonic acid, iduronic acid, isocitric acid, mannaric acid, mannonic acid, octulosonic acid, rhamnonic acid, ribonic acid, tagaturonic acid, xylonic acid, or xyluronic acid, a salt or derivative thereof, and a combination thereof.

6. The treatment fluid of claim 1, wherein the organic acid is present in the treatment fluid in a concentration in a range of about 0.1% w/v to about 25% w/v.

7. The treatment fluid of claim 1, wherein the aqueous base fluid is a brine having a dissolved solids content of 10,000 ppm or less.

8. A method for preventing the formation of scale, the method comprises:
providing a treatment fluid comprising:
polyamino polyether methylene phosphonate (PAPEMP),
aminoethylethanolamine tri(methylene phosphonate) (AEEA),
an organic acid, and
an aqueous base fluid,
introducing the treatment fluid into a wellbore penetrating a subterranean formation,
contacting a mineral in the wellbore with the treatment fluid thereby preventing further mineral formation and deposition.

9. The method of claim 8, wherein the mineral is a carbonate scale.

10. The method of claim 9, wherein the carbonate scale is calcite.

11. The method of claim 8, wherein a location of the mineral in the wellbore has a temperature in a range of about 220° F. to about 450° F.

12. The method of claim 8, wherein the method further comprises producing a fluid from the wellbore; wherein the produced fluid has a measurable CO₂ concentration of about 50% to about 100% of the gas phase of the produced fluid.

13. The method of claim 8, wherein the mineral is disposed on a piece of wellbore equipment located in the wellbore.

14. The method of claim 8, wherein the ratio of AEEA to PAPEMP in the treatment fluid is in a range of about 3:1 to about 1:3.

15. The method of claim 8, wherein the aqueous base fluid is a brine having a dissolved solids content of 10,000 ppm or less.

16. A system for preventing the formation of scale, the system comprises:
a treatment fluid comprising:
polyamino polyether methylene phosphonate (PAPEMP),
aminoethylethanolamine tri(methylene phosphonate) (AEEA),
an organic acid, and
an aqueous base fluid;
mixing equipment configured to mix the PAPEMP, AEEA, organic acid, and aqueous base fluid; and
pumping equipment configured to pump the treatment fluid into a wellbore.

17. The system of claim 16, further comprising a wellbore conduit; wherein the pumping equipment and treatment fluid are configured such that the treatment fluid contacts the wellbore conduit while the wellbore conduit is in the wellbore; wherein the wellbore conduit comprises a mineral disposed on a surface of the wellbore conduit.

18. The system of claim 17, wherein the mineral is calcite.

19. The system of claim 16, wherein the ratio of AEEA to PAPEMP in the treatment fluid is in a range of about 3:1 to about 1:3.

20. The system of claim 16, wherein the aqueous base fluid is a brine having a dissolved solids content of 10,000 ppm or less.
